(19) United States
(12) Patent Application Publication
(10) Pub. No.: US 2026/0344640 A1
(43) Pub. Date: Nov. 5, 2026

(54) METHOD FOR PROVIDING HERBICIDE APPLICATION DATA IN ORDER TO CONTROL A HERBICIDE PRODUCT APPLICATION DEVICE

(71) Applicant: BASF Agro Trademarks GmbH, Ludwigshafen am Rhein (DE)

(72) Inventors: Steffen TELGMANN, Koeln (DE); Holger HOFFMANN, Koeln (DE)

(21) Appl. No.: 19/108,096

(22) PCT Filed: Aug. 30, 2023
(86) PCT No.: PCT/EP2023/073761

§ 371 Date: Feb. 28, 2025

(30) Foreign Application Priority Data
Sep. 1, 2022 (EP) 22193382.3

(51) Int. Cl. A01M 7/00; G06V 10/764; G06V 20/10

(52) U.S. Cl. CPC A01M 7/0089; G06V 10/764; G06V 20/188

(57) ABSTRACT

Computer-implemented method for providing herbicide application data for applying a herbicide product on an agricultural field, comprising: providing image data of an agricultural field; providing a weed classification model configured to provide weed data based on the image data of the agricultural field; providing weed data for the agricultural field based on the weed classification model and the image data; providing a weed growth model configured to provide weed emergence data and/or weed growth data for the agricultural field based on the weed data for the agricultural field; providing weed emergence data and/or weed growth data for the agricultural field based on the weed growth model and the weed data for the agricultural field; providing herbicide application data at least comprising application timing data for at least one herbicide product for applying on the agricultural field.

### TECHNICAL FIELD

The present disclosure relates to a computer-implemented method for providing herbicide application data for applying a herbicide product on an agricultural field, an application device for applying a herbicide product on an agricultural field, a system for providing herbicide application data for applying a herbicide product on an agricultural field, a use of image data, weed data, weed emergence data and/or weed growth data in such a computer-implemented method and a respective computer program element.

### TECHNICAL BACKGROUND

The general background of this disclosure is the treatment of an agricultural field. The treatment of an agricultural field comprises the treatment of an agricultural field, a greenhouse, or the like, by herbicides in order to control unwanted weed plants.

In common agricultural practice, herbicide products are applied on agricultural fields on basis of experience, expertise, and knowledge of the farmers, for example by interpreting weed species, weed infestation, weather parameters, etc. in order to make a decision for or against the application of herbicide products. One of the key issues here is often when is the optimal time to apply herbicide products.

It has been found that a need exists to provide a method for providing robust and precise information about the application timing of herbicide products on an agricultural field.

### SUMMARY OF THE INVENTION

In the view of the above, it is an object of the present invention to provide a method for determining the optimal timing for herbicide application. In the view of the above, it is an object of the present invention to provide a method for determining the optimal dose rate for herbicide application. In the view of the above, it is an object of the present invention to provide the optimal herbicide application map for use in herbicide application devices. In the view of the above, it is an object of the present invention to provide a precise and easy-to-use method for generating control data for herbicide application devices—having a real-world impact—especially based on existing image data and/or existing models. These and other objects, which become apparent upon reading the following description, are solved by the subject matter of the independent claims. The dependent claims refer to preferred embodiments of the invention.

One aspect of the present disclosure relates to a computer-implemented method for providing herbicide application data for applying a herbicide product on an agricultural field, comprising:
providing image data of an agricultural field;
providing a weed classification model configured to provide weed data based on the image data of the agricultural field;
providing weed data for the agricultural field based on the weed classification model and the image data;
providing a weed growth model configured to provide weed emergence data and/or weed growth data for the agricultural field based on the weed data for the agricultural field;
providing weed emergence data and/or weed growth data for the agricultural field based on the weed growth model and the weed data for the agricultural field;
providing herbicide application data based on the weed emergence data and/or weed growth data, wherein the herbicide application data at least comprising application timing data for at least one herbicide product for applying on the agricultural field.

A further aspect of the present disclosure relates to a computer-implemented method for generating and/or providing control data usable for controlling a herbicide product application device for applying a herbicide product on an agricultural field, comprising:
providing image data of an agricultural field;
providing a weed classification model configured to provide weed data based on the image data of the agricultural field;
providing weed data for the agricultural field based on the weed classification model and the image data;
providing a weed growth model configured to provide weed emergence data and/or weed growth data for the agricultural field based on the weed data for the agricultural field;
providing weed emergence data and/or weed growth data for the agricultural field based on the weed growth model and the weed data for the agricultural field;
providing herbicide application data based on the weed emergence data and/or weed growth data, wherein the herbicide application data at least comprising application timing data for at least one herbicide product for applying on the agricultural field,
generating and/or providing control data usable for controlling a herbicide product application device based on the herbicide application data.

A further aspect of the present disclosure relates to an application device for applying a herbicide product on an agricultural field, wherein the herbicide application data for the application device are provided by a method as disclosed herein.

A further aspect of the present disclosure relates to a system for providing herbicide application data for applying a herbicide product on an agricultural field, comprising:
a first providing unit configured to provide image data of an agricultural field;
a second providing unit configured to provide a weed classification model configured to provide weed data based on the image data of the agricultural field;
a third providing unit configured to provide weed data for the agricultural field based on the weed classification model and the image data;
a fourth providing unit configured to provide a weed growth model configured to provide weed emergence data and/or weed growth data for the agricultural field based on the weed data for the agricultural field;
a fifth providing unit configured to provide weed emergence data and/or weed growth data for the agricultural field based on the weed growth model and the weed data for the agricultural field; and
a sixth providing unit configured to provide herbicide application data based on the weed emergence data and/or weed growth data, wherein the herbicide application data at least comprising application timing data for at least one herbicide product for applying on the agricultural field.

A further aspect of the present disclosure relates to an apparatus for providing herbicide application data for applying a herbicide product on an agricultural field, the apparatus comprising: one or more computing nodes; and one or more computer-readable media having thereon computer-executable instructions that are structured such that, when executed by the one or more computing nodes, cause the apparatus to perform the following steps:
providing image data of an agricultural field;
providing a weed classification model configured to provide weed data based on the image data of the agricultural field;
providing weed data for the agricultural field based on the weed classification model and the image data;
providing a weed growth model configured to provide weed emergence data and/or weed growth data for the agricultural field based on the weed data for the agricultural field;
providing weed emergence data and/or weed growth data for the agricultural field based on the weed growth model and the weed data for the agricultural field;
providing herbicide application data based on the weed emergence data and/or weed growth data, wherein the herbicide application data at least comprising application timing data for at least one herbicide product for applying on the agricultural field.

A further aspect of the present disclosure relates to a use of image data, weed data, weed emergence data and/or weed growth data in a computer-implemented method as disclosed herein and/or a use of herbicide application data and/or control data usable for controlling a herbicide application device.

A further aspect of the present disclosure relates to a computer program element with instructions, which, when executed on computing devices of a computing environment, is configured to carry out the steps of the computer-implemented method as disclosed herein in a system as disclosed herein and/or in an apparatus as disclosed herein.

The embodiments described herein relate to the method, the system, the apparatus, the application device, the computer program element lined out above and vice versa. Advantageously, the benefits provided by any of the embodiments and examples equally apply to all other embodiments and examples and vice versa.

As used herein “determining” also includes “estimating, calculating, initiating or causing to determine”, “generating” also includes “initiating or causing to generate”, and “providing” also includes “initiating or causing to determine, generate, select, send, query or receive”.

The method, device, system, application device, apparatus, computer program element, disclosed herein provide robust and precise information about the application timing of herbicide products on an agricultural field. It is an object of the present invention to provide an efficient, sustainable and robust way for providing herbicide application data at least comprising timing data for applying a herbicide product on an agricultural field in order to increase the effectivity of the application of a herbicide product avoiding unnecessary treating and/or over treatment of the agricultural field, and saving money and amounts of treating products and having less environmental impact.

These and other objects, which become apparent upon reading the following description, are solved by the subject matters of the independent claims. The dependent claims refer to preferred embodiments of the invention.

The term image data of an agricultural field as used herein is to be understood broadly in the present case and is not limited to any specific data format. Moreover, the image and/or the image data may be provided by any means, e.g. a remote camera unit and/or by means device/machine mounted camera units. In addition, the term image data may also encompass any already processed image data, in which, for example, several images of the agricultural field/area have been merged and processed.

The term weed classification model as used herein is to be understood broadly in the present case and is not limited to any specific model. In this respect, it is preferred that the weed classification model is configured to classify/identify weed plants, weed species, weed plant size, weed distribution and/or weed relevance (e.g. in view of size and/or the growth stage of the crop). In this respect any known image recognition algorithms may be applied. The term weed data as used herein is to be understood broadly in the present case and is not limited to any specific data format. The weed data at least comprises the output data of the weed classification model, e.g. information about the classified weed plants, weed species, weed plant size, weed distribution and/or weed relevance for the crop. The term weed growth model as used herein is to be understood broadly in the present case and is not limited to any specific model. The weed growth model may be applied for back-calculation to determine the past time of weed emergence and/or the past optimal timing of a herbicide application. This back-calculation data can then be used to determine a herbicide application time for the next season. However, the weed growth model may be applied for pre-calculation/prediction to determine a herbicide application in the same season, e.g. in a specific growth stage of the weed. The term weed emergence data as used herein is to be understood broadly in the present case and at least comprises the information about the emergence of the weed and/or the respective weed. The term weed growth data as used herein is to be understood broadly in the present case and at least comprises the information about one or more predetermined growth stages of a specific weed plant.

The term agricultural field as used herein is to be understood broadly in the present case and presents any area, i.e. surface and subsurface, of a soil to be treated with a herbicide product. The agricultural field may be any plant or crop cultivation area, such as a farming field, a greenhouse, or the like. A plant may be a crop, a weed, a volunteer plant, a crop from a previous growing season, a beneficial plant or any other plant present on the agricultural field. The agricultural field may be identified through its geographical location or geo-referenced location data. A reference coordinate, a size and/or a shape may be used to further specify the agricultural field.

The term herbicide application data as used herein is to be understood broadly in the present case and presents any data providing information about an application of a herbicide product on the agricultural field at least comprising a time and/or time window for applying the herbicide product on the agricultural field. Notably, this time and/or time window may be in the present season and/or in the next season(s). Further, the herbicide application data may include suitability data giving information about at least one herbicide product suitable for an application on the agricultural field at least based on the weed data/weed species. Furthermore, the herbicide application data may include dose rate data. The dose rate for applying a herbicide product on the agricultural field may be provided for the surface or sub-areas of the agricultural field. Furthermore, the herbicide application data may be provided by a herbicide application map. The herbicide application map may be a 2-dimensional application map. The herbicide application data may comprise instructions, tasks for application devices, and/or applicators to guide an application of the herbicide product.

The term herbicide product as used herein is to be understood broadly in the present case and presents any herbicide material to be applied on an agricultural field. Herbicides can specifically be referred to as selective or non-selective herbicides. A selective herbicide controls specific weed species, while leaving the desired crop relatively unharmed. In contrast, a non-selective herbicide, e.g. called total weed killers, kill all plant material with which they come into contact. A herbicide may be at least one of the following, but is not limited thereto: acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas. Further, a herbicide may be, but are not limited thereto, lipid biosynthesis inhibitors, acetolactate synthase inhibitors (ALS inhibitors), photosynthesis inhibitors, protoporphyrinogen-IX oxidase inhibitors, bleacher herbicides, enolpyruvyl shikimate 3-phosphate synthase inhibitors (EPSP inhibitors), glutamine synthetase inhibitors, 7,8-dihydropteroate synthase inhibitors (DHP inhibitors), mitosis inhibitors, inhibitors of the synthesis of very long chain fatty acids (VLCFA inhibitors), cellulose biosynthesis inhibitors, decoupler herbicides, auxinic herbicides, auxin transport inhibitors, and/or other herbicides selected from the group consisting of bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, indaziflam, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine, tetflupyrolimet, triaziflam, tridiphane, and their agriculturally acceptable salts, amides, Isoxaflutole, Flufenacet, Aclonifen, Atrazin, Terbutylazin, S-Metolachlor, Metolachlor, Metribuzin, S-Metolachlor, Pendimethalin, Acetochlor, Pyroxasulfone, Cloransulam-methyl, Imazamethayr, Dimethenamid-P, Metamitrion, Ethofumesate, Quimerac, Prosulfocarb, Chlortoluron, Cinmethylin, Pendimethalin, esters or thioesters, Mesotrione, Tembotrione, Clopyralid, Sulfentrazone, Saflufenacil, Imazethapyr, Imazamox, Trifluralin, Triallate.

The term weed distribution data as used herein is to be understood broadly in the present case and presents any data/information defining or indicating the existence, distribution and/or appearance of weed plants on the agricultural field. Weed plants are unwanted plants which populations can be managed by using herbicides. The weed distribution data may be depicted as 2-dimensonal for one season or a plurality of seasons. The weed distributing data may be historical data indicating/depicting areas of high appearance/high density, i.e. hot-spots, of weeds. The weed distribution data may be provided by scouting, camera or sensor based mapping analysis methods.

The term crop data as used herein is to be understood broadly in the present case and presents any data defining, indicating or giving information about crops being planned to be planted on the agricultural field. The crop data may include data/information about the species of the crop plant and if relevant the herbicide tolerance, trait conditions, in particular soil conditions, enabling a fastest, fruitfullest and productive growth of the crop plant. The crop data may include information about actually planned crop but also about following crop to check on waiting periods. The crop data may be provided by a user via a user interface.

The term historical treatment data as used herein is to be understood broadly in the present case and presents any data/information providing, defining, describing or indicating historical treatments of the agricultural field. Specifically, the historical treatment data may comprise information about treatments performed in previous seasons on the agricultural field. The historical treatment data may be provided as 2-dimensional maps of the agricultural field depicting either treatment information for one specific previous season/sum of a plurality of specific previous seasons, e.g. depending on weather influences, or a sum for all previous seasons. The historical treatment data are provided by a database and/or a data system.

The term control data as used herein is to be understood broadly in the present case and presents any data being configured to operate and control an application device. The control data are provided by a control unit and may be configured to control one or more technical means of the application device, e.g. the drive control but is not limited thereto.

The term application device used herein is to be understood broadly in the present case and represents any device being configured to provide/spread seeds, plants and/or fertilizers on the soil of an agricultural field. The application device may be configured to traverse the agricultural field. The application device may be a ground or an air vehicle, e.g. a rail vehicle, a robot, an aircraft, an unmanned aerial vehicle (UAV), a drone, or the like. The application device can be an autonomous or a non-autonomous application device.

The term spot application as used herein is to be understood broadly in the present case and presents any data providing information required or about a spot application of the second agricultural product on the agricultural field. Such a spot application may be performed as so called on/off application or as a variable application of the further agricultural product. The latter means that not every spot and/or not an entire spot is provided with the same application rate, but with a variable application rate.

The term providing as used herein is to be understood broadly in the present case and represents any providing, receiving, querying, measuring, calculating, determining, transmitting of data, but is not limited thereto. Data may be provided by a user via a user interface, depicted/shown to a user by a display, and/or received from other devices, queried from other devices, measured other devices, calculated by other device, determined by other devices and/or transmitted by other devices.

The term data as used herein is to be understood broadly in the present case and represents any kind of data. Data may be single numbers/numerical values, a plurality of a numbers/numerical values, a plurality of a numbers/numerical values being arranged within a list, 2 dimensional maps or 3 dimensional maps, but are not limited thereto.

In an embodiment of the method for providing herbicide application data, the image data of the agricultural field may be provided by means of at least one remote camera unit and/or by means device/machine mounted camera units, e.g. a sprayer device.

In an embodiment of the method for providing herbicide application data, the image data of the agricultural field may be provided for a time when at least one weed species in the agricultural field has a growth stage between certain BBCH stages, for example between BBCH 6 and BBCH 10, or between BBCH 8 and BBCH 12. In an embodiment of the method for providing herbicide application data, the image data of the agricultural field may be provided for a time when at least one weed species in the agricultural field has a specific size (e.g. a specific leaf size).

In an embodiment of the method for providing herbicide application data, the weed classification model may be configured to classify weed species and/or plants based on an analysis of the leaves of a weed plant, preferably based on leaf size, leaf geometry, leaf shape and/or leaf color of a weed plant.

In an embodiment of the method for providing herbicide application data, the weed classification model may be configured to classify weed plants according to weed species, extent of infestation, weed plant size, weed distribution and/or weed relevance.

In an embodiment of the method for providing herbicide application data, the weed growth model may be configured to provide emergence time data for at least one weed species on the agricultural field. These calculated estimated emergence data can be used, for example, to adjust the application of a herbicide in the next planting season. For example, it can be determined when the weeds shown in the images have emerged. Based on this, it can be determined when the best time would have been to apply a herbicide, for example, starting from the time of sowing. This information can be used, for example, in the next planting season to apply a herbicide as close as possible to the time when a respective weed emerge, e.g. before the weeds sprout.

In an embodiment of the method for providing herbicide application data, the weed growth model may be configured to provide growth stage time data for at least one weed species, wherein the growth stage time data preferably refers to a growth stage of the weed species between BBCH 11 and BBCH 14, most preferably to a growth stage of the weed species of BBCH 12. Certain herbicides may act more through the leaves, so-called foliar herbicides, or more through the roots of the weed, so-called soil herbicides, an appropriate herbicide may be applied at the most optimal time based on the growth rate of the weed.

In an embodiment of the method for providing herbicide application data, the method may further comprise:
providing historical weather data, actual weather data and/or predicted weather data; and
wherein the weed growth model is further configured to provide weed emergence data and/or weed growth data for the agricultural field further based on the weather data. Since the efficacy of some herbicides, e.g. soil herbicides, may dependent on a sufficient precipitation, in order to transport a soil herbicide to the roots of the plants, weather data may be used to decided to select a specific herbicide product, e.g. a specific soil herbicide dependent on the cumulative precipitation amount.

In an embodiment of the method for providing herbicide application data, the method may further comprise:
providing historical weed distribution data for the agricultural field; and wherein the weed growth model is further configured to provide weed emergence data and/or weed growth data for the agricultural field further based on the historical weed distribution data. Because weeds may often occur in recurring local distributions, such weed distribution data, for example from previous seasons, may improve the application of a herbicide

In an embodiment of the method for providing herbicide application data, the method may further comprise:
providing historical treatment data comprising information about treatments performed in previous seasons on the agricultural field, preferably comprising information about the mode of the historical treatment action; and wherein the weed growth model is further configured to provide weed emergence data and/or weed growth data for the agricultural field further based on the historical treatment data. By taking into account historical treatment data, for example, the risk of resistance formation due to the use of repetitive agents may be reduced.

In an embodiment of the method for providing herbicide application data, the method may further comprise:
providing crop data comprising information about crops planted and/or planned to be planted on the agricultural field; and wherein
providing herbicide application data is further based on the crop data. For example, by considering crop data, it is possible to evaluate whether a particular weed is at all harmful to a particular crop. In addition, the growth stage of the crop may also be taken into account. For example, it may be evaluated when a certain weed is no longer harmful for a certain growth stage of the corps, e.g. at a certain size of the crop, it may be determined that certain smaller weeds are essentially no longer harmful to the crop because the crop can suppress the weeds itself.

In an embodiment of the method for providing herbicide application data, the herbicide application data may spot application data for spot applying the herbicide product.

In an embodiment of the method for providing herbicide application data, the herbicide application data may comprise at least one of the following:
application time data comprising at least one-time window for applying a herbicide product on the agricultural field;
suitability data about at least one herbicide product suitable for an application on the agricultural field at least based on the weed data and/or the classified weed species;
dose rate data comprising at least one dose rate for applying a herbicide product on the agricultural field, wherein dose rates for applying a herbicide product are preferably provided for sub-areas of the agricultural field;
dose rate data comprising at least one threshold value for applying a herbicide product indicating at which threshold value an application with the herbicide product is performed;
spatial variation data related to sub-field areas of the agricultural field; and/or at least one herbicide application map.

In an embodiment of the method for providing herbicide application data, the method may further comprise: generating and/or providing control data usable for controlling a herbicide product application device based on the herbicide application data.

### BRIEF DESCRIPTION OF THE DRAWINGS

In the following, the present disclosure is further described with reference to the enclosed figures:

FIG. 1 illustrate example embodiments of a centralized and a decentralized computing environment with computing nodes;

FIG. 2 illustrate example embodiments of a centralized and a decentralized computing environment with computing nodes;

FIG. 3 illustrate an example embodiment of a distributed computing environment;

FIG. 4 illustrates a flow diagram of a computer-implemented method for providing herbicide application data;

FIG. 5 illustrates a schematic illustration of a system for providing combined application data; and

FIG. 6 illustrates exemplarily the different possibilities to receive and process field data.

### DETAILED DESCRIPTION OF EMBODIMENT

The following embodiments are mere examples for implementing the method, the system, the apparatus, or application device disclosed herein and shall not be considered limiting.

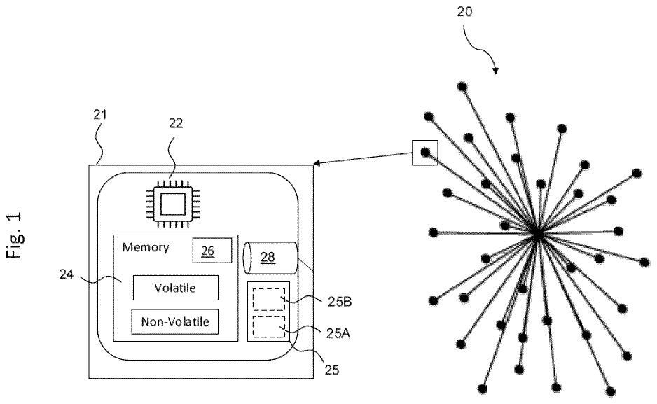

FIGS. 1 to 3 illustrate different computing environments, central, decentral and distributed.

The methods, apparatuses, computer elements of this disclosure may be implemented in decentral or at least partially decentral computing environments. In particular, for data sharing or exchange in ecosystems of multiple players different challenges exist. Data sovereignty may be viewed as a core challenge. It can be defined as a natural person's or corporate entity's capability of being entirely self-determined with regard to its data. To enable this particular capability related aspects, including requirements for secure and trusted data exchange in business ecosystems, may be implemented across the chemical value chain. In particular, chemical industry requires tailored solutions to deliver chemical products in a more sustainable way by using digital ecosystems. Providing, determining or processing of data may be realized by different computing nodes, which may be implemented in a centralized, a decentralized or a distributed computing environment.

FIG. 1 illustrates an example embodiment of a centralized computing system 20 comprising a central computing node 21 (filled circle in the middle) and several peripheral computing nodes 21.1 to 21.n (denoted as filled circles in the periphery). The term “computing system” is defined herein broadly as including one or more computing nodes, a system of nodes or combinations thereof. The term “computing node” is defined herein broadly and may refer to any device or system that includes at least one physical and tangible processor, and/or a physical and tangible memory capable of having thereon computer-executable instructions that are executed by a processor. Computing nodes are now increasingly taking a wide variety of forms. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In this example, the peripheral computing nodes 21.1 to 21.n may be connected to one central computing system (or server). In another example, the peripheral computing nodes 21.1 to 21.n may be attached to the central computing node via e.g. a terminal server (not shown). The majority of functions may be carried out by, or obtained from the central computing node (also called remote centralized location). One peripheral computing node 21.n has been expanded to provide an overview of the components present in the peripheral computing node. The central computing node 21 may comprise the same components as described in relation to the peripheral computing node 21.n.

Each computing node 21, 21.1 to 21.n may include at least one hardware processor 22 and memory 24. The term “processor” may refer to an arbitrary logic circuitry configured to perform basic operations of a computer or system, and/or, generally, to a device which is configured for performing calculations or logic operations. In particular, the processor, or computer processor may be configured for processing basic instructions that drive the computer or system. It may be a semi-conductor based processor, a quantum processor, or any other type of processor configures for processing instructions. As an example, the processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processor may be a multicore processor. Specifically, the 13 processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified.

The memory 24 may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, non-magnetic disk storage such as solid-state disk or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

The computing nodes 21, 21.1 to 21.n may include multiple structures 26 often referred to as an “executable component, executable instructions, computer-executable instructions or instructions”. For instance, memory 24 of the computing nodes 21, 21.1 to 21.n may be illustrated as including executable component 26. The term “executable component” or any equivalent thereof may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component includes software objects, routines, methods, and so forth, that is executed on the computing nodes 21, 21.1 to 21.n, whether such an executable component exists in the heap of a computing node 21, 21.1 to 21.n, or whether the executable component exists on computer-readable storage media. In such a case, one of ordinary skill in the art will recognize that the structure of the executable component exists on a computer-readable medium such that, when interpreted by one or more processors of a computing node 21, 21.1 to 21.n (e.g., by a processor thread), the computing node 21, 21.1 to 21n is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”. Examples of executable components implemented in hardware include hardcoded or hard-wired logic gates, that are implemented exclusively or near-exclusively in hardware, such as within a field-programmable gate array (FPGA), an application-specific integrated circuit (ASIC), or any other specialized circuit. In this description, the terms “component”, “agent”, “manager”, “service”, “engine”, “module”, “virtual machine” or the like are used synonymous with the term “executable component.

The processor 22 of each computing node 21, 21.1 to 21.n may direct the operation of each computing node 21, 21.1 to 21.n in response to having executed computer-executable instructions that constitute an executable component. For example, such computer-executable instructions may be embodied on one or more computer-readable media that form a computer program product. The computer-executable instructions may be stored in the memory 24 of each computing node 21, 21.1 to 21.n. Computer-executable instructions comprise, for example, instructions and data which, when executed at a processor 21, cause a general purpose computing node 21, 21.1 to 21.n, special purpose computing node 21, 21.1 to 21.n, or special purpose processing device to perform a certain function or group of functions.

Alternatively or in addition, the computer-executable instructions may configure the computing node 21, 21.1 to 21.n to perform a certain function or group of functions. The computer executable instructions may be, for example, binaries or even instructions that undergo some translation (such as compilation) before direct execution by the processors, such as intermediate format instructions such as assembly language, or even source code.

Each computing node 21, 21.1 to 21.n may contain communication channels 28 that allow each computing node 21.1 to 21.n to communicate with the central computing node 21, for example, a network (depicted as solid line between peripheral computing nodes and the central computing node in FIG. 1). A “network” may be defined as one or more data links that enable the transport of electronic data between computing nodes 21, 21.1 to 21.n and/or modules and/or other electronic devices. When information is transferred or provided over a network or another communications connection (either hardwired, wireless, or a combination of hardwired or wireless) to a computing node 21, 21.1 to 21.n, the computing node 21, 21.1 to 21.n properly views the connection as a transmission medium. Transmission media can include a network and/or data links which can be used to carry desired program code means in the form of computer-executable instructions or data structures and which can be accessed by a general-purpose or special-purpose computing nodes 21, 21.1 to 21.n. Combinations of the above may also be included within the scope of computer-readable media.

The computing node(s) 21, 21.1 to 21.n may further comprise a user interface system 25 for use in interfacing with a user. The user interface system 25 may include output mechanisms 25A as well as input mechanisms 25B. The principles described herein are not limited to the precise output mechanisms 25A or input mechanisms 25B as such will depend on the nature of the device. However, output mechanisms 25A might include, for instance, displays, speakers, displays, tactile output, holograms and so forth. Examples of input mechanisms 25B might include, for instance, microphones, touchscreens, holograms, cameras, keyboards, mouse or other pointer input, sensors of any type, and so forth.

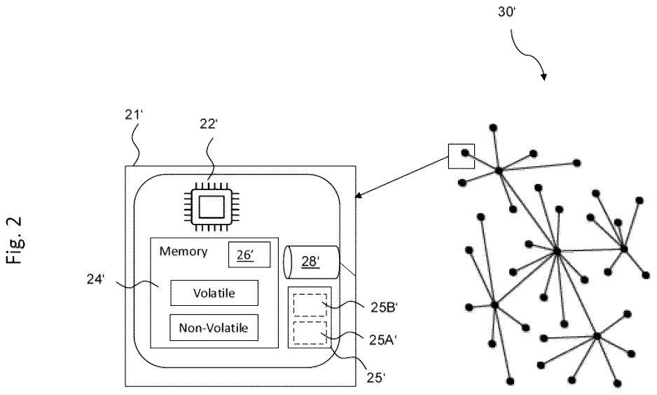

FIG. 2 illustrates an example embodiment of a decentralized computing environment 30 with several computing nodes 21.1 to 21.n denoted as filled circles. In contrast to the centralized computing environment 20 illustrated in FIG. 1, the computing nodes 21.1 to 21.n of the decentralized computing environment are not connected to a central computing node 21 and are thus not under control of a central computing node. Instead, resources, both hardware and software, may be allocated to each individual computing node 21.1 to 21.n (local or remote computing system) and data may be distributed among various computing nodes 21.1 to 21.n to perform the tasks. Thus, in a decentral system environment, program modules may be located in both local and remote memory storage devices. One computing node 21 has been expanded to provide an overview of the components present in the computing node 21. In this example, the computing node 21 comprises the same components as described in relation to FIG. 1.

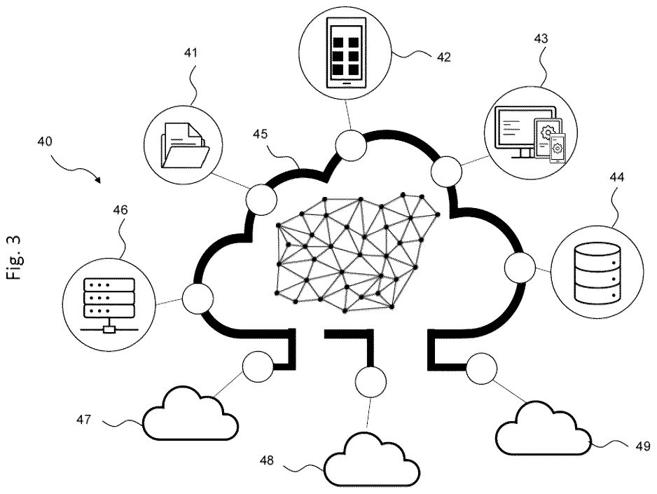

FIG. 3 illustrates an example embodiment of a distributed computing environment 40. In this description, “distributed computing” may refer to any computing that utilizes multiple computing resources. Such use may be realized through virtualization of physical computing resources.

One example of distributed computing is cloud computing. “Cloud computing” may refer a model for enabling on-demand network access to a shared pool of configurable computing resources (e.g., networks, servers, storage, applications, and services). When distributed, cloud computing environments may be distributed internationally within an organization and/or across multiple organizations. In this example, the distributed cloud computing environment 40 may contain the following computing resources: mobile device(s) 42, applications 43, databases 44, data storage and server(s) 46. The cloud computing environment 40 may be deployed as public cloud 47, private cloud 48 or hybrid cloud 49. A private cloud 47 may be owned by an organization and only the members of the organization with proper access can use the private cloud 48, rendering the data in the private cloud at least confidential. In contrast, data stored in a public cloud 48 may be open to anyone over the internet. The hybrid cloud 49 may be a combination of both private and public clouds 47, 48 and may allow to keep some of the data confidential while other data may be publicly available.

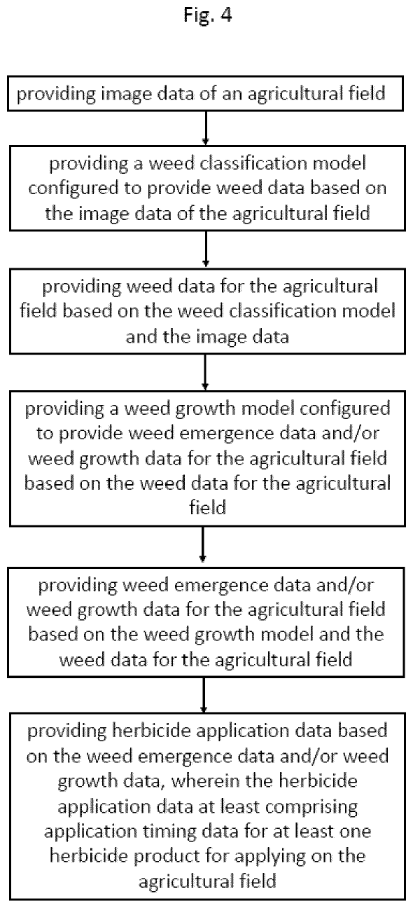

FIG. 4 illustrates a flow diagram of an example method for providing for providing herbicide application data for applying a herbicide product on an agricultural field.

In a first step, providing image data of an agricultural field are provided, e.g. by means of a camera unit mounted on a sprayer device. In a second step, a weed classification model configured to provide weed data based on the image data of the agricultural field is provided. In a further step, the weed classification model is applied to process the provided image data and to provide weed data as an output data. The weed data may comprise information about the weed plants, weed species, weed plant size, weed distribution, weed relevance for the crop, etc. In a further step, the provided weed data is used as input data for a provided weed growth model which is configured to provide weed emergence data and/or weed growth data for the agricultural field based on the weed data for the agricultural field. The weed emergence data and/or the weed growth data may subsequently be used to provide herbicide application data at least comprising application timing data for at least one herbicide product, wherein the timing data may refer to the same season and/or to a subsequent season. In other words, the weed growth model may be applied for back-calculation to determine the time of weed emergence and/or the optimal timing of a herbicide application. This back-calculation data can then be used to determine a herbicide application time for the next season. However, the weed growth model may be applied for pre-calculation/prediction to determine a herbicide application in the same season, e.g. in a specific growth stage of the weed.

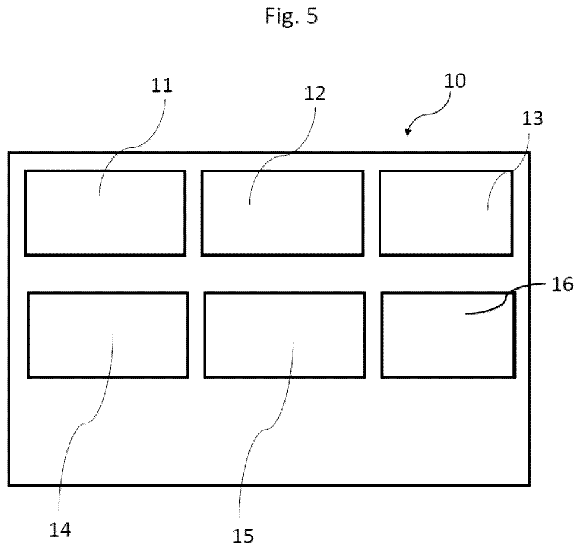

FIG. 5 illustrates a schematic illustration of a system 10 for providing for providing herbicide application data for applying a herbicide product on an agricultural field. The system 10 for providing herbicide application data may comprise a first providing unit 11 configured to provide image data of an agricultural field, a second providing unit 12 configured to provide a weed classification model configured to provide weed data based on the image data of the agricultural field, a third providing unit 13 configured to provide weed data for the agricultural field based on the weed classification model and the image data; a fourth providing unit 14 configured to provide a weed growth model configured to provide weed emergence data and/or weed growth data for the agricultural field based on the weed data for the agricultural field; a fifth providing unit 15 configured to provide weed emergence data and/or weed growth data for the agricultural field based on the weed growth model and the weed data for the agricultural field; and a sixth providing 16 unit configured to provide herbicide application data based on the weed emergence data and/or weed growth data, wherein the herbicide application data at least comprising application timing data for at least one herbicide product for applying on the agricultural field.

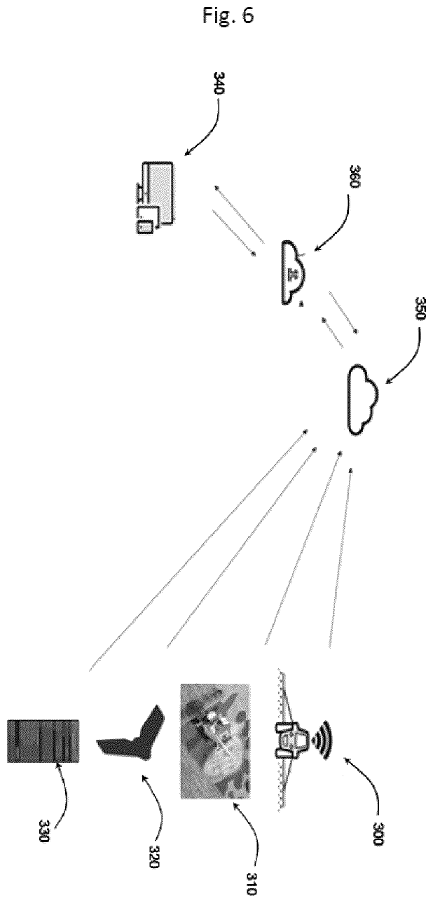

FIG. 6 illustrates exemplarily the different possibilities to receive and process field data.

For example, field data can be obtained by all kinds of agricultural equipment 300 (e.g. a tractor 300) as so-called as-applied maps by recording the application rate at the time of application. It is also possible that such agricultural equipment comprises sensors (e.g. optical sensors, cameras, infrared sensors, soil sensors, etc.) to provide, for example, a weed distribution map. It is also possible that during harvesting the yield (e.g. in the form of biomass) is recorded by a harvesting vehicle 310. Furthermore, corresponding maps/data can be provided by land-based and/or airborne drones 320 by taking images of the field or a part of it. Finally, it is also possible that a geo-referenced visual assessment 330 is performed and that this field data is also processed. Field data collected in this way can then be merged in a computing device 340, where the data can be transmitted and computed, for example, via any wireless link, cloud applications 350 and/or working platforms 360, wherein the field data may also be processed in whole or in part in the cloud application 350 and/or in the working platform 360 (e.g., by cloud computing).

Aspects of the present disclosure relates to computer program elements configured to carry out steps of the methods described above. The computer program element might therefore be stored on a computing unit of a computing device, which might also be part of an embodiment. This computing unit may be configured to perform or induce performing of the steps of the method described above. Moreover, it may be configured to operate the components of the above described system. The computing unit can be configured to operate automatically and/or to execute the orders of a user. The computing unit may include a data processor. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfill the procedure of an exemplary embodiment of the method as described above. According to a further exemplary embodiment of the present disclosure, a computer readable medium, such as a CD-ROM, USB stick, a downloadable executable or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

The following embodiments 1 to 20 are preferred embodiments of the present invention.

### Embodiments of the Invention

### Embodiment 1

Computer-implemented method for providing herbicide application data for applying a herbicide product on an agricultural field, comprising:
providing image data of an agricultural field;
providing a weed classification model configured to provide weed data based on the image data of the agricultural field;
providing weed data for the agricultural field based on the weed classification model and the image data;
providing a weed growth model configured to provide weed emergence data and/or weed growth data for the agricultural field based on the weed data for the agricultural field;
providing weed emergence data and/or weed growth data for the agricultural field based on the weed growth model and the weed data for the agricultural field;
providing herbicide application data based on the weed emergence data and/or weed growth data, wherein the herbicide application data at least comprising application timing data for at least one herbicide product for applying on the agricultural field.

### Embodiment 2

Computer-implemented method according to Embodiment 1, wherein the image data of the agricultural field are provided by means of at least one remote camera unit and/or by means device/machine mounted camera units.

### Embodiment 3

Computer-implemented method according to Embodiment 1 or Embodiment 2, wherein the image data of the agricultural field are provided when at least one weed species in the agricultural field has a growth stage between BBCH 6 and BBCH 10 or between BBCH 8 and BBCH 12.

### Embodiment 4

Computer-implemented method according to any one of the preceding Embodiments, wherein the weed classification model is configured to classify weed species and/or plants based on an analysis of the leaves of a weed plant, preferably based on leaf size, leaf geometry, leaf shape and/or leaf color of a weed plant.

### Embodiment 5

Computer-implemented method according to any one of the preceding Embodiments, wherein the weed classification model is configured to classify weed plants according to weed species, extent of infestation, weed plant size, weed distribution and/or weed relevance.

### Embodiment 6

Computer-implemented method according to any one of the preceding Embodiments, wherein the weed growth model is configured to provide emergence time data for at least one weed species on the agricultural field.

### Embodiment 7

Computer-implemented method according to any one of the preceding Embodiments, wherein the weed growth model is configured to provide growth stage time data for at least one weed species, wherein the growth stage time data preferably refers to a growth stage of the weed species between BBCH 11 and BBCH 14, most preferably to a growth stage of the weed species of BBCH 12.

### Embodiment 8

Computer-implemented method according to any one of the preceding Embodiments, further comprising:
providing historical weather data, actual weather data and/or predicted weather data; and wherein the weed growth model is further configured to provide weed emergence data and/or weed growth data for the agricultural field further based on the weather data.

### Embodiment 9

Computer-implemented method according to any one of the preceding Embodiments, further comprising:
providing historical weed distribution data for the agricultural field; and wherein the weed growth model is further configured to provide weed emergence data and/or weed growth data for the agricultural field further based on the historical weed distribution data.

### Embodiment 10

Computer-implemented method according to any one of the preceding Embodiments, further comprising:
providing historical treatment data comprising information about treatments performed in previous seasons on the agricultural field, preferably comprising information about the mode of the historical treatment action; and wherein the weed growth model is further configured to provide weed emergence data and/or weed growth data for the agricultural field further based on the historical treatment data.

### Embodiment 11

Computer-implemented method according to any one of the preceding Embodiments, wherein the weed growth model is applied for back-calculation to determine the past time of weed emergence and/or the past optimal timing of a herbicide application, and optionally wherein these back-calculation data are used to determine a herbicide application time for the next season or optionally wherein these back-calculation data are applied for pre calculation/prediction to determine a herbicide application in the same season, particularly in a specific growth stage of the weed.

### Embodiment 12

Computer-implemented method according to any one of the preceding Embodiments, further comprising:
providing crop data comprising information about crops planted and/or planned to be planted on the agricultural field; and wherein
providing herbicide application data is further based on the crop data.

### Embodiment 13

Computer-implemented method according to any one of the preceding Embodiments, wherein the herbicide application data are spot application data for spot applying the herbicide product.

### Embodiment 14

Computer-implemented method according to any one of the preceding Embodiments, wherein the herbicide application data comprises at least one of the following:
application time data comprising at least one-time window for applying a herbicide product on the agricultural field;
suitability data about at least one herbicide product suitable for an application on the agricultural field at least based on the weed data and/or the classified weed species;
dose rate data comprising at least one dose rate for applying a herbicide product on the agricultural field, wherein dose rates for applying a herbicide product are preferably provided for sub-areas of the agricultural field;
dose rate data comprising at least one threshold value for applying a herbicide product indicating at which threshold value an application with the herbicide product is performed;
spatial variation data related to sub-field areas of the agricultural field; and/or
at least one herbicide application map.

### Embodiment 15

Computer-implemented method according to any one of the preceding Embodiments, further comprising: generating and/or providing control data usable for controlling a herbicide product application device based on the herbicide application data.

### Embodiment 16

Application device for applying a herbicide product on an agricultural field, wherein the herbicide application data are provided by a method according to any one of Embodiments 1 to 15.

### Embodiment 17

System for providing herbicide application data for applying a herbicide product on an agricultural field, comprising:
a first providing unit configured to provide image data of an agricultural field;
a second providing unit configured to provide a weed classification model configured to provide weed data based on the image data of the agricultural field;
a third providing unit configured to provide weed data for the agricultural field based on the weed classification model and the image data;
a fourth providing unit configured to provide a weed growth model configured to provide weed emergence data and/or weed growth data for the agricultural field based on the weed data for the agricultural field;
a fifth providing unit configured to provide weed emergence data and/or weed growth data for the agricultural field based on the weed growth model and the weed data for the agricultural field; and
a sixth providing unit configured to provide herbicide application data based on the weed emergence data and/or weed growth data, wherein the herbicide application data at least comprising application timing data for at least one herbicide product for applying on the agricultural field.

### Embodiment 18

An apparatus for providing herbicide application data for applying a herbicide product on an agricultural field, the apparatus comprising: one or more computing nodes; and one or more computer-readable media having thereon computer-executable instructions that are structured such that, when executed by the one or more computing nodes, cause the apparatus to perform the following steps:
providing image data of an agricultural field;
providing a weed classification model configured to provide weed data based on the image data of the agricultural field;
providing weed data for the agricultural field based on the weed classification model and the image data;
providing a weed growth model configured to provide weed emergence data and/or weed growth data for the agricultural field based on the weed data for the agricultural field;
providing weed emergence data and/or weed growth data for the agricultural field based on the weed growth model and the weed data for the agricultural field;
providing herbicide application data based on the weed emergence data and/or weed growth data, wherein the herbicide application data at least comprising application timing data for at least one herbicide product for applying on the agricultural field.

### Embodiment 19

Use of image data, weed data, weed emergence data and/or weed growth data in a computer-implemented method according to any one of Embodiments 1 to 15 and/or use of herbicide application data and/or control data for controlling a herbicide application device.

### Embodiment 20

Computer program element with instructions, which, when executed on computing devices of a computing environment, is configured to carry out the steps of the computer-implemented method according to any one of the Embodiments 1 to 15 in a system according to Embodiment 17 or in an apparatus according to Embodiment 18.

The present disclosure has been described in conjunction with a preferred embodiment as examples as well. However, other variations can be understood and effected by those persons skilled in the art and applying the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer-implemented method for generating and/or providing control data usable for controlling a herbicide product application device for applying a herbicide product on an agricultural field, comprising:
providing image data of an agricultural field;
providing a weed classification model configured to provide weed data based on the image data of the agricultural field;
providing weed data for the agricultural field based on the weed classification model and the image data;
providing a weed growth model configured to provide weed emergence data and/or weed growth data for the agricultural field based on the weed data for the agricultural field;
providing weed emergence data and/or weed growth data for the agricultural field based on the weed growth model and the weed data for the agricultural field;
providing herbicide application data based on the weed emergence data and/or weed growth data, wherein the herbicide application data at least comprising application timing data for at least one herbicide product for applying on the agricultural field; and
generating and/or providing control data usable for controlling a herbicide product application device based on the herbicide application data.

2. The computer-implemented method according to claim 1, wherein the image data of the agricultural field are provided by means of at least one remote camera unit and/or by means device/machine mounted camera units.

3. The computer-implemented method according to claim 1, wherein the image data of the agricultural field are provided when at least one weed species in the agricultural field has a growth stage between BBCH 6 and BBCH 10 or between BBCH 8 and BBCH 12.

4. The computer-implemented method according to claim 1,
wherein the weed classification model is configured to classify weed species and/or plants based on an analysis of the leaves of a weed plant, optionally based on leaf size, leaf geometry, leaf shape and/or leaf color of a weed plant,
or wherein the weed classification model is configured to classify weed plants according to weed species, extent of infestation, weed plant size, weed distribution and/or weed relevance.

5. The computer-implemented method according to claim 1,
wherein the weed growth model is configured to provide emergence time data for at least one weed species on the agricultural field,
or wherein the weed growth model is configured to provide growth stage time data for at least one weed species, wherein the growth stage time data optionally refers to a growth stage of the weed species between BBCH 11 and BBCH 14.

6. The computer-implemented method according to claim 1, further comprising:
providing historical weather data, actual weather data and/or predicted weather data; and
wherein the weed growth model is further configured to provide weed emergence data and/or weed growth data for the agricultural field further based on the weather data.

7. The computer-implemented method according to claim 1, further comprising:
providing historical weed distribution data for the agricultural field; and wherein the weed growth model is further configured to provide weed emergence data and/or weed growth data for the agricultural field further based on the historical weed distribution data.

8. The computer-implemented method according to claim 1, further comprising:
providing historical treatment data comprising information about treatments performed in previous seasons on the agricultural field, optionally comprising information about the mode of the historical treatment action; and wherein the weed growth model is further configured to provide weed emergence data and/or weed growth data for the agricultural field further based on the historical treatment data.

9. The computer-implemented method according to claim 1, wherein the herbicide application data are spot application data for spot applying the herbicide product.

10. The computer-implemented method according to claim 1, wherein the herbicide application data comprises at least one of the following:
application time data comprising at least one-time window for applying a herbicide product on the agricultural field;
suitability data about at least one herbicide product suitable for an application on the agricultural field at least based on the weed data and/or the classified weed species;
dose rate data comprising at least one dose rate for applying a herbicide product on the agricultural field, wherein dose rates for applying a herbicide product are provided for sub-areas of the agricultural field;
dose rate data comprising at least one threshold value for applying a herbicide product indicating at which threshold value an application with the herbicide product is performed;
spatial variation data related to sub-field areas of the agricultural field; and/or
at least one herbicide application map.

11. An application device for applying a herbicide product on an agricultural field, wherein the herbicide application data are provided by a method according to claim 1.

12. A system for providing herbicide application data for applying a herbicide product on an agricultural field, comprising:
a first providing unit configured to provide image data of an agricultural field;
a second providing unit configured to provide a weed classification model configured to provide weed data based on the image data of the agricultural field;
a third providing unit configured to provide weed data for the agricultural field based on the weed classification model and the image data;
a fourth providing unit configured to provide a weed growth model configured to provide weed emergence data and/or weed growth data for the agricultural field based on the weed data for the agricultural field;
a fifth providing unit configured to provide weed emergence data and/or weed growth data for the agricultural field based on the weed growth model and the weed data for the agricultural field; and
a sixth providing unit configured to provide herbicide application data based on the weed emergence data and/or weed growth data, wherein the herbicide application data at least comprising application timing data for at least one herbicide product for applying on the agricultural field.

13. An apparatus for providing herbicide application data for applying a herbicide product on an agricultural field, the apparatus comprising: one or more computing nodes; and one or more computer-readable media having thereon computer-executable instructions that are structured such that, when executed by the one or more computing nodes, cause the apparatus to perform the following steps:
providing image data of an agricultural field;
providing a weed classification model configured to provide weed data based on the image data of the agricultural field;
providing weed data for the agricultural field based on the weed classification model and the image data;
providing a weed growth model configured to provide weed emergence data and/or weed growth data for the agricultural field based on the weed data for the agricultural field;
providing weed emergence data and/or weed growth data for the agricultural field based on the weed growth model and the weed data for the agricultural field; and
providing herbicide application data based on the weed emergence data and/or weed growth data, wherein the herbicide application data at least comprising application timing data for at least one herbicide product for applying on the agricultural field.

14. (canceled)

15. A computer program element with instructions, which, when executed on computing devices of a computing environment, is configured to carry out the steps of the computer-implemented method according to claim 1.
